(19) United States
(12) Patent Application Publication
(10) Pub. No.: US 2025/0259077 A1
(43) Pub. Date: Aug. 14, 2025

(54) EMPOWERING RESOURCE-CONSTRAINED IOT EDGE DEVICES: A HYBRID APPROACH FOR EDGE DATA ANALYSIS

(71) Applicant: UNIVERSITY OF SOUTH FLORIDA, Tampa, FL (US)

(72) Inventor: Srinivas KATKOORI, Tampa, FL (US)

(21) Appl. No.: 19/050,092

(22) Filed: Feb. 10, 2025

Related U.S. Application Data
(60) Provisional application No. 63/552,081, filed on Feb. 9, 2024.

(51) Int. Cl. G06N 5/01; G06N 20/10

(52) U.S. Cl. CPC G06N 5/01; G06N 20/10

(57) ABSTRACT

Methods and systems are provided herein for generating optimized, hybrid machine learning models capable of performing tasks such as classification and inference in IoT environments. The models may be deployed as optimized, task-specific (and/or environment-specific) hardware components (e.g., custom chips to perform the machine learning tasks) or lightweight applications that can operate on resource constrained devices. The hybrid models may comprise hybridization modules that integrate output of one or more machine learning models, according to sets of hyperparameters that are refined according to the task and/or environment/sensor data that will be used by the IoT device.

### CROSS-REFERENCE TO RELATED APPLICATION(S)

This application claims priority to U.S. Provisional Patent Application Ser. No. 63/552,081 filed Feb. 9, 2024, the content of which is hereby incorporated by reference in its entirety.

### STATEMENT REGARDING FEDERALLY SPONSORED RESEARCH

N/A

### BACKGROUND

IoT has led to an increase in data generation at the edge of the network. This increase in data is due to the sensors, actuators, and embedded systems integrated into edge devices. However, these devices often face constraints in computational resources. This limitation creates challenges when attempting to deploy resource-intensive machine learning (ML) algorithms directly on them. The constraints in processing power, memory capacity, and the need for energy efficiency create a demand for the development of hardware-friendly ML models designed to enable decision-making at the edge.

The growth of Internet of Thing (IoT) has resulted in a shift in computing from centralized processing to distributed and decentralized systems. This shift requires decision-making capabilities at the edge, where data is generated, to support real-time analysis and response. The deployment of complex ML models directly on resource-constrained edge devices is often unfeasible due to their limitations. As a result, there is a need to design and implement hardware-friendly ML models that can operate within these constraints and support decision-making at the edge for IoT applications.

Thus, there exists a need to move away from methods of deploying complex machine learning models directly on resource-constrained edge devices and instead, adopt more efficient approaches that address the challenges of limited computational resources, memory constraints, energy efficiency, and latency. One way to achieve this balance is through the design and implementation of efficient chip architectures that can perform specific operations more effectively than general-purpose processors, reducing power consumption and cost.

The present disclosure introduces a hybrid ML model designed to address these challenges. By incorporating both supervised and unsupervised ML techniques, the model integrates Principal Component Analysis (PCA), decision tree (DT), and support vector machine (SVM) classifiers to improve hardware ML inference models for decision-making at the IoT edge. The hybrid model is tailored to efficiently utilize limited computational resources while ensuring accuracy and reliability on IoT edge devices. PCA is employed as a preprocessing step to reduce the dimensionality of the input data, extracting the most informative features and minimizing the computational and memory load. This reduction in dimensionality results in optimized feature vectors better suited for resource-constrained IoT edge devices.

The combination of DT and SVM classifiers within the hybrid model offers a robust approach for handling the diverse patterns and complexities found in IoT data. DTs capture intricate relationships and generate interpretable predictions, making them effective for understanding the underlying data structure. SVM classifiers, on the other hand, excel at handling nonlinear data and achieving high classification accuracy. By combining the strengths of both models, the hybrid approach aims to improve performance in terms of accuracy, interpretability, and generalization on IoT edge devices.

In the present disclosure, energy efficiency, a critical factor for IoT edge devices operating under limited energy sources, is prioritized. The integration of PCA for dimensionality reduction, along with optimized hyperparameters obtained through grid search, minimizes unnecessary computations and energy consumption. Through effective resource management, the model ensures energy-efficient operation while maintaining high levels of accuracy and performance. This hybrid model can be directly deployed at the IoT edge or further optimized using hardware techniques to generate application-specific integrated circuits (ASICs) for IoT applications.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure can provide a method for generating a task-specific and environment-specific hybrid machine learning (ML) model for an Internet of Things device (IoT), the method comprising: receiving information defining a classification task to be performed by the IoT device based on data sensed from an environment in which the IoT device will be deployed; determining a training data set corresponding to the classification task and environment; obtaining a hybrid ML model comprising a data reduction module, at least one decision tree (DT) model, at least one support vector machine (SVM) model, and a hybridization module; determining an initial plurality of hyperparameters of the data reduction module, wherein at least one of the hyperparameters is limited in adjustability by a maximum or minimum value, according to a task-specific attribute, and processing the training data set using the data reduction model according to its hyperparameters to create a reduced training data set; determining an initial plurality of hyperparameters for the DT model and an initial plurality of hyperparameters for the SVM model, based at least in part on: the plurality of hyperparameters of the data reduction module, a resource constraint of the IoT device, and the information defining the classification task to be performed by the IoT device; training the DT model and SVM model using the reduced training data set, according to the plurality of hyperparameters for the DT model and plurality of hyperparameters for the SVM model; determining an initial plurality of hyperparameters of the hybridization module, the hyperparameters configured to cause the hybridization module to integrate outputs of the DT model and SVM model according to the information defining the classification task to be performed; adjusting an output format of the DT model and SVM model to conform to the hyperparameters of the hybridization module; evaluating performance of the hybrid ML model, and if performance does not meet a criteria of the information defining the classification task, iteratively adjusting at least one of the plurality of hyperparameters of the data reduction module, the DT model, and the SVM model, re-training the DT model and SVM model, and re-evaluating performance of the hybrid ML model; and after performance of the hybrid ML model meets the criteria of the information defining the classification task, deploying the hybrid ML model for use in the IoT device.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a block diagram conceptually illustrating a system for hybrid data analysis, according to some embodiments.

FIG. 2 is a flowchart illustrating an example process for training a machine learning using a hybrid model approach, according to some embodiments.

FIG. 3 is a flowchart illustrating an example runtime process for a hybrid machine learning model, according to some embodiments.

FIG. 4 is a diagram of a workflow directed to a hybrid model architecture framework including a resource-efficient inference model for a hardware implementation.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

Various embodiments, features, and examples of the present disclosure can also be found in the attached appendices, comprising academic articles which describe the inventors' work. These articles support the breadth of and are not limiting of the scope of the present disclosure

### Example Hybrid Data Analysis System

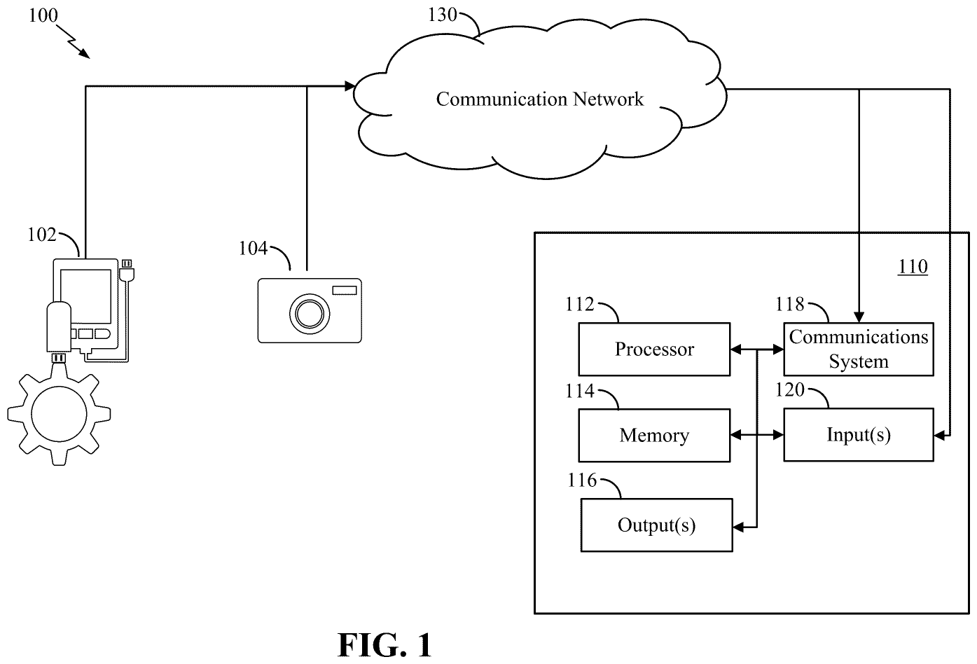

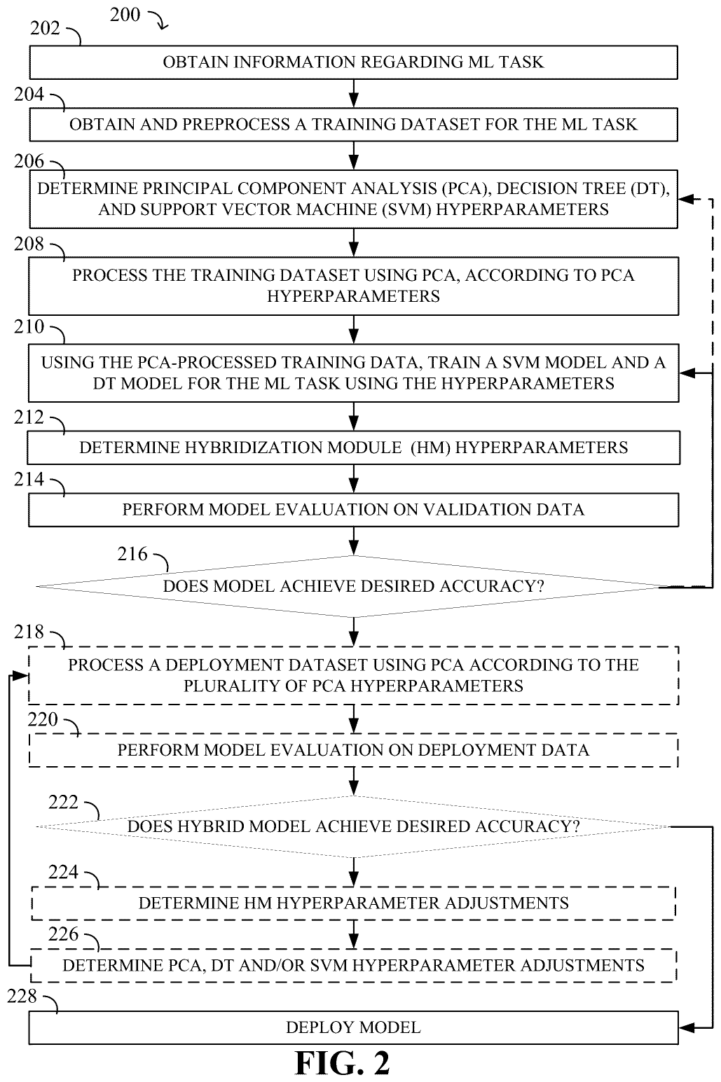

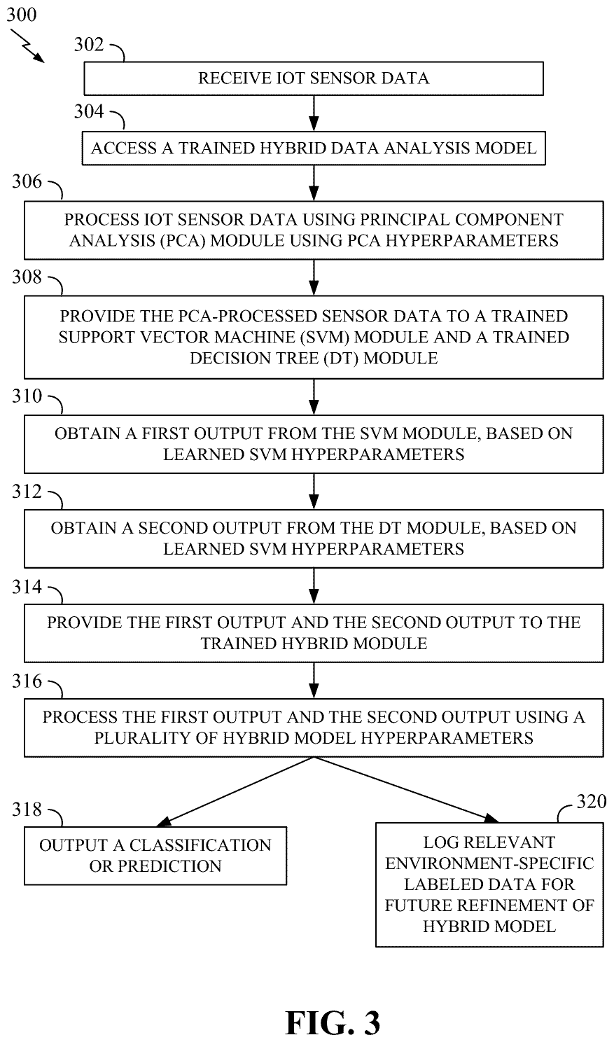

FIG. 1 shows a block diagram illustrating a system 100 for hybrid data analysis on IoT devices, edge devices, or other resource constrained devices for which computational offloading is not feasible or desired. A computing device 110 can be an internet of things (IoT) edge device, such as a single-board computer, a computing chip, a router, a camera, or any suitable computing device. Thus, the processes described in FIGS. 2 and 3 may be tied to training and running hybrid data analysis models for a specific “local” sensing device.

In the system 100, a computing device 110 can obtain or receive a dataset. The dataset can be sensor data received from an integrated or connected sensor, such as motion data, force data, temperature data, vibration or acoustic data, various electrical signal measurements, or the like. In further embodiments, the data may be higher order data such as a heart disease dataset 102, a breast cancer dataset 104, a lung cancer dataset, a fetal health dataset, or any other suitable dataset for which classifications and/or predictions will be made. For example, the dataset can include an image set (e.g., a video, stream, or timeseries), a medical record, X-ray data, electrical signal data, weather readings, LiDAR or depth sensor data, or any other suitable data for classification. In other examples, the dataset can include one or more features or vectors extracted from the sensor data. The computing device 110 can receive the dataset, whether from a sensor or as stored in a database, via communication network 130 and a communications system 118 or an input 120 of the computing device 110.

In some embodiments, the processor 112 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc.

The memory 114 can include any suitable storage device or devices that can be used to store suitable data (e.g., the dataset, a trained neural network model, a hybrid machine learning model, etc.) and instructions that can be used, for example, by the processor 112 to: when receiving a runtime dataset for a sensing application via the set of inputs 120, process the data using principal component analysis (PCA) according to PCA hyperparameters and obtain outputs 116 by providing the PCA-processed sensor data to a trained support vector machine (SVM) and decision tree (DT) machine learning model. The memory 114 can include a non-transitory computer-readable medium including any suitable volatile memory, non-volatile memory, storage, or any suitable combination thereof. For example, memory 114 can include random access memory (RAM), read-only memory (ROM), electronically-erasable programmable read-only memory (EEPROM), one or more flash drives, one or more hard disks, one or more solid state drives, one or more optical drives, etc. In some embodiments, the processor 112 can execute at least a portion of process described below in connection with FIG. 3.

The computing device 110 can further include a communications system 118. The communications system 118 can include any suitable hardware, firmware, and/or software for communicating information over the communication network 140 and/or any other suitable communication networks. For example, the communications system 118 can include one or more transceivers, one or more communication chips and/or chip sets, etc. In a more particular example, the communications system 118 can include hardware, firmware and/or software that can be used to establish a Wi-Fi connection, a Bluetooth connection, a cellular connection, an Ethernet connection, etc.

The computing device 110 can receive or transmit information (e.g., dataset 102, 104, a disease prediction indication 140, a trained neural network, etc.) and/or any other suitable system over a communication network 130. In some examples, the communication network 130 can be any suitable communication network or combination of communication networks. For example, the communication network 130 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 130 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

In some examples, the computing device 110 can further include an output 116. The output 116 can include a set of output pins to output a prediction or classification. In other examples, the output 116 can include a display to output a prediction indication. In some embodiments, the display 116 can include any suitable display devices, such as a computer monitor, a touchscreen, a television, an infotainment screen, etc. to display a report containing a classification or prediction. In further examples, the prediction or classification can be transmitted to another system or device over the communication network 130. In further examples, the computing device 110 can include an input 120 using any suitable input devices (e.g., a keyboard, a mouse, a touchscreen, a microphone, etc.) and/or the one or more sensors that can produce the raw sensor data or the dataset 102, 104.

### Example Hybrid Machine Learning Model Training Process

FIG. 2 is a flow diagram illustrating an example process 200 for training and/or refining a hybrid classification model, according to some embodiments. As described below, a particular implementation can omit some or all illustrated blocks, techniques, or steps, may be implemented in some embodiments in a different order, and may not require some illustrated features to implement all embodiments. In some examples, an apparatus (e.g., computing device 110, etc.) in connection with FIG. 1 can be used to perform all or part of example process 200. However, it should be appreciated that other suitable processing hardware for carrying out the operations or features described below may perform process 200.

At block 202, process 200 obtains information regarding a given machine learning (ML) task. For example, a ML task may include a classification task that is presented, involving classification of a given number of possible output classes/labels and given type(s) and dimensionality of input information. The information may also contain details of the computing environment in which the ML task will take place, such as processing power, available memory, power consumption requirements, timing and latency demands, acceptable accuracy tradeoffs, etc. The details of the ML task may be defined by user input to a software program, or may be distilled automatically from a training set and its labels.

Thus, at block 204, a training dataset may be obtained and pre-processed according to the ML task. (In some embodiments blocks 202 and 204 may be combined or performed in parallel). A training dataset may include labeled input data samples representative of the given classification problem. The specific nature of the training dataset may depend on a classification problem at hand. As examples to illustrate, if the task involves monitoring industrial equipment to predict potential failures, the dataset may include historical sensor readings collected from various machines, labeled according to whether the data corresponds to normal operation or an impending malfunction or maintenance need. If the task pertains to anomaly detection in an electrical load signal, the dataset may consist of voltage and current waveforms labeled as either normal variations or indicators of a potential fault, machine malfunction, etc.

Preprocessing may involve data normalization, feature scaling, noise reduction, windowing, pruning irrelevant information, and outlier removal, thereby ensuring that the input data is consistent and suitable for analysis. The dataset may be collected from multiple sources, including real-world sensors, historical logs, and synthetic datasets generated through augmentation techniques. In some embodiments, process 200 may reference a library of datasets with various labels, such as acoustic data labeled with a variety of sound classifications, electric signals output by various physical sensors (e.g., electrodes, vibration sensors, accelerometers, and other similar devices that may be utilized in wearable, IoT, and other resource-constrained or edge systems, etc.) labeled with various domain-specific labels (e.g., activity classification, disease states, etc.). In other embodiments, process 200 may receive a new dataset specific to the given classification task. In further embodiments, process 200 may combine a general library (e.g., of acoustic data labeled as sounds) with a new dataset of specific sensor data (e.g., acoustic data labeled as a given sound(s) of interest, like a griding gear, doorbell, animal sound, etc.) of the same modality, and may in some circumstances weight the specific data higher (e.g., where there is a data imbalance). Thus, preprocessing may also be utilized to conform different datasets for combination.

At block 206, process 200 determines various hyperparameters that may suit processing of the data by the hybrid model being developed. This may entail determination of one or more sets of hyperparameters for various tasks, including data reduction/feature extraction, decision tree classification, support vector machine classification, and hybridization (as described below). Embodiments of process 200 may determine some or all hyperparameters for any of these three tasks, in addition to or in lieu of other similar tasks.

In some embodiments, process 200 may determine how best to process the preprocessed training dataset using a feature extraction or dimensionality reduction technique, such as principal component analysis (PCA). This may include determining a plurality of data reduction and feature extraction settings and/or hyperparameters, such as PCA hyperparameters. In some embodiments, PCA serves as a dimensionality reduction technique that transforms high-dimensional or complex/large input data into a desired smaller set of data components, which exhibit the most meaningful variance in the data or otherwise best define the pertinent information of a dataset. Other examples of dimensionality reduction techniques may include Fourier transforms, wavelet transforms, autoencoders, compression algorithms, feature selection techniques like variance thresholding, statistical regularization (like L1/LASSO), singular value decomposition (SVD), linear discriminate analysis, recursive feature elimination, mutual information, etc., which may depend upon the nature of the input data and its labels and the ML task. For example, for noisy sensor data, techniques like Fourier and wavelet transform may be more useful, whereas for classification tasks, LDA and various feature extraction techniques may be more useful.

The data processing that will occur with respect to block 208 (and, ultimately, used in the generated model) can be useful for reducing dimensionality of input data to achieve a corresponding reduction in computational requirement of the hybrid model (e.g., for resource-constrained or IoT devices, or where latency is important), but can also aid in focusing the model on features that are most important to the given ML task. For example, reducing dimensionality can help with eliminating redundant or weakly informative features, given the type of classification task, while retaining the most relevant information for classification. The effectiveness of PCA in reducing computational complexity can be particularly helpful for resource-constrained systems such as IoT devices, where minimizing processing and memory requirements is essential for real-time operation.

In some embodiments, the application of PCA may involve determining one or more PCA hyperparameters that will affect how principal components are selected and data is reduced. One such hyperparameter is the number of retained components, which determines how much of the total variance in the dataset should be preserved. In some embodiments, process 200 may select a fixed number of principal components based on empirical studies or domain-specific knowledge of the dataset's feature importance. In other embodiments, process 200 may determine the number of retained components dynamically based on an explained variance threshold, ensuring that only components contributing significantly to the variance of the data are retained while discarding lower-variance components. In some embodiments, the Principal Component Analysis (PCA) algorithm used for data reduction or feature extraction may include standard PCA, Incremental PCA for streaming data, Sparse PCA for enforcing sparsity in the principal components, Kernel PCA for capturing non-linear relationships, or Truncated SVD (Singular Value Decomposition) for dimensionality reduction in high-dimensional sparse data. The specific PCA hyperparameters that may be considered can include: parameters defining the number of principal components to retain, the explained variance threshold for selecting components dynamically, whether to apply whitening to normalize feature variance, the choice of solver (e.g., full SVD, randomized SVD, or eigenvalue decomposition), batch size for Incremental PCA, and the kernel type for Kernel PCA (e.g., linear, polynomial, or RBF kernel). These hyperparameters may be selected based on computational constraints, input data characteristics, and the desired balance between dimensionality reduction and information preservation. In further embodiments, alternative data reduction or transformation techniques may also be utilized, such as various Fourier transforms and similar algorithms (either before or in addition to the PCA techniques).

In some examples, PCA hyperparameters that cause more significant reduction may be particularly beneficial, such as when the training dataset includes highly correlated features, as is common in sensor-based datasets where multiple readings capture overlapping information. For example, in a classification task involving the detection of electrical faults in an industrial setting, raw current and voltage readings may contain significant redundancy (e.g., voltage may not vary by much, exhibiting only infrequent and comparatively small drops, whereas current may fluctuate with some regularity until a major spike or drop occurs). By applying PCA, process 200 can extract the most informative aspects of the data that differentiate normal operating conditions from fault conditions, thereby improving classifier performance and reducing inference latency.

In some embodiments, the hyperparameters applicable to the data reduction processing may be designated as adjustable, non-adjustable, or adjustable only within a range. These categories may be determined according to the type of input data and the type of device (e.g., resource constrained IoT device) that will be utilizing the model, so that any hyperparameter refinements and adjusting (as described below) does not cause the resulting model to be unsuitable for its ultimate deployment. In further embodiments, PCA hyperparameters may be selected in accordance with the computational limitations of the deployment environment, for example with a maximum limitation on the number of principal components retained for systems with stricter processing constraints.

Also at block 206, process 200 may determine hyperparameters for one or more machine learning models that are suitable for running locally in IoT, edge, and other resource-constrained devices. In other words, the computational (and power) demand and memory requirement of the models must be conducive to devices that do not have powerful multi-core processors, graphics processing units, sophisticated cooling mechanisms, rapid memory access capabilities, or large amounts of storage. Thus, most neural networks (e.g., convolutional neural networks) would not be suitable, and instead non-neural network machine learning models may be used. For example, decision tree (DT) models, support vector machine (SVM) models, and similar classifiers or regressors allow for classification and prediction operations without the high storage and computational demands of neural networks and other deep learning methods. A variety of types of decision tree models may be utilized, depending upon the nature of the ML task, attributes of the training data and anticipated deployment/run-time data, and computational environment. In some embodiments, the classification models used to generate inputs for the hybridization module may include decision tree-based models such as Classification and Regression Trees (CART), Reduced-Error Pruned Decision Trees, Extremely Randomized Trees (Extra Trees), Hoeffding Trees for streaming data, or ensembles such as Random Forest and Gradient-Boosted Decision Trees (e.g., LightGBM, XGBoost). Similarly, support vector machine (SVM) models may include Lincar SVMs for simple decision boundaries, Kernel SVMs (using RBF, Polynomial, or Sigmoid kernels) for more complex separability, Least Squares SVMs (LS-SVM) for fast training, or Sparse SVMs to minimize memory footprint for edge deployments. In further embodiments, alternative classifiers may be used, such as k-Nearest Neighbors (k-NN) with optimized search structures, Naïve Bayes for lightweight probabilistic classification, Logistic Regression for binary classification tasks, Rule-Based Classifiers for interpretable decision-making, and Fuzzy Logic classifiers for handling uncertain or imprecise data. The specific classifiers utilized may be selected based on the nature of the classification task, computational constraints, and deployment environment, as well as comparative strengths of other models that will be utilized in the same hybrid model.

For non-neural network machine learning models, their hyperparameters influence their structure (e.g., developed during training), such as what data they process, how they process that data and what their outputs can be, and can significantly impact classification accuracy and efficiency. The selection of hyperparameters may be performed using various strategies, including manual tuning based on domain expertise, automated optimization methods such as grid search or Bayesian optimization, or adaptive tuning based on deployment-specific requirements.

For decision tree models, hyperparameters may include the maximum tree depth, which limits how deeply the tree grows to prevent overfitting, the minimum number of samples required to split a node, which ensures that each node split is based on a sufficient number of training samples to maintain statistical significance, and the impurity criterion, which defines how process 200 evaluates the effectiveness of different splits. The impurity criterion may be selected as Gini impurity, which measures the likelihood of misclassification if a given node were randomly classified, or entropy, which measures the information gain provided by a given split. In embodiments where the classification task involves a large number of classes, process 200 may select entropy-based splitting to maximize information gain, whereas in binary classification tasks, Gini impurity may be preferable due to its computational efficiency.

For SVM models, hyperparameters may include the choice of kernel function, which determines how input data is transformed into a higher-dimensional space for classification, the regularization parameter (C), which controls the tradeoff between classification accuracy and generalization, and the gamma parameter, which defines the influence range of individual training samples in non-linear kernel spaces. The selection of kernel type may be influenced by the dataset's complexity; for example, if the dataset exhibits a linearly separable structure, a linear kernel may be chosen for computational efficiency, whereas if the dataset contains complex decision boundaries, a radial basis function (RBF) kernel may be selected to enable non-linear classification. The regularization parameter C may be tuned according to the class distribution, with higher values selected when minimizing classification error is critical and lower values selected when generalization is preferred over precise separation of training data.

In some embodiments, these hyperparameters may be automatically determined based on characteristics of the raw input data, or may depend upon hyperparameters of the data reduction/feature extraction processing. For example, where a substantial data reduction takes place via a PCA processing prior to input data being processed by an SVM model, the kernel type selection may depend upon (or be influenced by) the resulting nature of the reduced input data. In other embodiments, the regularization parameter may depend upon the computational resource constraints and how much the input data was reduced, as well as the degree to which latency vs. accuracy is prioritized for the ML task at hand. Thus, the hyperparameters for SVM models may also be categorized (e.g., as part of block 202) as “adjustable,” “not adjustable,” or “adjustable within a range, limit, or minimum.”

At block 208, process 200 processes the training dataset using PCA (or other technique) according to one or more determined hyperparameters. As noted above, some hyperparameters may be determined or set (e.g., not adjustable) according to the nature of the ML task involved, such as a computational limit. Other hyperparameters may initially be selected based upon final hyperparameter selection for similar datasets (e.g., object recognition in similar images, electrical load sensing, mechanical vibration sensing, etc.) and similar computational environments, subject to future adjustment (as described below). In other embodiments, where no initial hyperparameter settings with some associated likelihood of success (from past efforts) is available or believed to be workable, then alternative approaches may be taken for selection of hyperparameters, including naïve approaches like grid search, etc. (as also described below).

At block 210, process 200 trains the decision tree and support vector machine models using the PCA-processed dataset and the selected hyperparameters. Training involves optimizing model parameters to best capture the statistical patterns present in the training data. The decision tree may be trained by recursively partitioning the feature space into subregions that maximize class purity, progressively constructing a hierarchical structure where each split improves classification accuracy. The training process may involve pruning techniques that reduce the risk of overfitting by removing branches that do not contribute meaningfully to classification accuracy. In some embodiments, process 200 may employ cost-complexity pruning, where nodes that contribute marginal accuracy improvements but significantly increase model complexity are removed.

The SVM model may be trained by identifying an optimal hyperplane that maximizes the margin between different class labels, ensuring that new samples can be classified with high confidence. Training involves solving an optimization problem that balances classification accuracy with generalization, which may be performed using techniques such as stochastic gradient descent or sequential minimal optimization (SMO). During training, process 200 may evaluate different kernel transformations to determine whether the selected kernel function sufficiently captures the dataset's class separability.

As noted above with respect to PCA hyperparameters, the DT and/or SVM hyperparameters used when training the respective models may initially be selected based on information regarding the ML task at hand, computational constraints, input data characteristics (including as may be modified by PCA), ranges, limits, and minimum values. For hyperparameters that are amendable to adjustment, informed initial selections may be made or approaches may be undertaken (e.g., grid search) to test various combinations of values.

At block 212, process 200 determines hyperparameters for a hybridization module, which will serve to process output results from the DT and SVM models. In some embodiments, therefore, the hybridization module may operate to integrate or synthesize the outputs of these classifiers to generate a final classification decision. As described below, the hybridization module may be configured to identify strengths and weaknesses of these models and intelligently interpret their output in a way that is specific to the ML task at all. Thus, selection of hyperparameters for the hybridization module influences how classification outputs are interpreted and aggregated, the confidence assigned to different predictions, how conflicting or uncertain results are addressed, and whether additional validation mechanisms are applied before finalizing the classification.

For example, in some embodiments, process 200 may determine a voting approach for synthesizing outputs from the DT and SVM models. A hard voting strategy may be selected, in which each classifier provides a discrete class prediction, and the final classification is determined based on a majority vote. If both (or a majority, if more than 2) classifiers agree on a class label, the hybridization module outputs that label. If they disagree (or there is no majority), a predefined tie-breaking rule may be used, such as prioritizing the classifier with the highest validation accuracy, prioritizing the class output that has the highest confidence/likelihood, or deferring to a predetermined default class (which may be static, or dynamic based on past output classification determinations). Hard voting may be particularly effective when the DT and SVM models exhibit complementary strengths, allowing their consensus to drive classification confidence.

In other embodiments, process 200 may determine that a soft voting strategy is preferable, in which each classifier provides a probability distribution over possible class labels rather than a discrete classification. The hybridization module may then compute a weighted average of these probability scores, assigning higher importance to classifiers that have demonstrated greater accuracy on validation data. The weighting factors may be determined through hyperparameter tuning, optimizing the balance between classifiers based on their respective strengths in different classification scenarios. Soft voting may be particularly beneficial when classification confidence varies across different regions of the feature space, allowing the hybridization module to assign greater weight to the more reliable classifier for a given input.

In further implementations, process 200 may configure the hybridization module to apply a secondary validation mechanism to classification outputs that do not exhibit either a consensus (hard voting) or a high overall confidence (soft voting) or to all classification outputs. One such approach may involve computing a distance metric between the current input data being processed and reference points in feature space associated with each class. For example, if PCA was used for dimensionality reduction, process 200 may determine whether the PCA-processed input data is sufficiently close to the average representation of its assigned class (or at least has a high match with one or more highly predictive components), to help ensure that an unusual or incorrect classification is not output due to operation of the module (e.g., multiple low confidence thresholds adding up to the highest confidence level, when one of the models had a very high confidence in a different class). If the computed distance exceeds a predefined threshold, the hybridization module may reject the classification and instead select the next best classification or trigger a fallback mechanism.

In further embodiments, process 200 may determine whether the hybridization module should generate an output that is not merely the highest-likelihood class. For example, some hyperparameters may dictate whether to include an “unknown” classification option for cases where model confidence is too low to assign a definitive label, or there are multiple highly confident but conflicting output classifications. Instead of forcing a decision when both classifiers produce low-confidence outputs or conflicting predictions, the hybridization module may be configured to classify the input as “unknown,” prompting further action such as requesting human review, triggering additional data collection (e.g., augmenting a signal by using an external aid, like turning on or moving a light, re-sampling a signal at a higher or different rate, initiating an additional sensor, etc.) or deferring classification until additional context is available. The threshold for triggering an “unknown” classification may be determined based on hyperparameters such as minimum confidence scores, the degree of agreement between classifiers, or the input data's deviation from known class distributions.

Relatedly, where more than one output classification has a high confidence across models, the hybridization module may output more than one classification. For example, an electrical load signal might reflect two devices having turned on or malfunctioned at the same time, or an image stream might reflect more than one object in a given image. Thus, process 200 may also determine whether the hybridization module should employ ranking-based classification, in which multiple candidate classes are considered rather than selecting a single classification outright. Instead of outputting only the top-scoring classification, the module may return a ranked list of potential labels, with confidence scores assigned to each. This approach may be useful in applications where classification certainty varies, allowing downstream processes to incorporate confidence information when making decisions.

At block 214, process 200 may combine the PCA, DT, SVM and hybridization modules into a software pipeline for performing the ML task, and then perform model evaluation using validation data to assess the performance of the trained DT, SVM, and hybridization module. The validation dataset may include labeled examples that were not used during training, allowing process 200 to estimate how well the hybrid classification model generalizes to unseen data. In some embodiments, the validation dataset may be derived from the same source as the training data but withheld from model training to provide an unbiased evaluation. In other embodiments, cross-validation techniques such as k-fold validation may be used, dividing the dataset into multiple subsets for iterative training and testing. In other embodiments, validation may be performed using a simulation, such as a real-world test of environmental conditions an IoT device would be configured to assess (e.g., placing objects of interest in a camera's field of view to determine accuracy of the hybrid model).

During evaluation, process 200 may compute multiple performance metrics to assess classification accuracy and reliability. Standard metrics such as classification accuracy, precision, recall, and F1-score may be used to quantify overall performance, while additional metrics such as area under the receiver operating characteristic (ROC) curve (AUC-ROC) may provide insight into how well the model distinguishes between classes. In cases where the dataset exhibits imbalanced class distributions, process 200 may compute additional metrics such as balanced accuracy or class-weighted F1-scores to ensure that performance is not skewed by majority-class dominance.

If validation results indicate that the hybrid classification model achieves acceptable classification accuracy, process 200 may determine that the model is suitable for deployment (block 228) and does not need to further refine or re-train the model. However, if performance falls below predefined thresholds or it is desired to explore whether higher accuracies can be achieved, process 200 may determine that further refinements are warranted. These refinements may include adjusting hyperparameters for the PCA, DT, SVM, or hybridization module, modifying training strategies, or incorporating additional preprocessing techniques to enhance data quality.

In some embodiments, process 200 may conduct error analysis to identify patterns in misclassified validation samples, providing insights into model weaknesses. If errors are concentrated in specific regions of the feature space, process 200 may determine that additional feature engineering is necessary to improve separability between classes. If misclassifications predominantly occur for a particular class, process 200 may reweight training samples to increase the model's sensitivity to that class.

In further embodiments, process 200 may evaluate how well the hybridization module integrates classifier outputs by analyzing cases where the DT and SVM produce conflicting classifications. If the hybridization module frequently overrides the better-performing classifier, process 200 may adjust weighting parameters or modify hybridization strategies to enhance classification robustness. Similarly, if validation results indicate that the hybridization module frequently assigns the “unknown” classification, process 200 may determine whether the confidence threshold should be adjusted to reduce unnecessary rejections.

If process 200 determines that further improvements are necessary, it may iterate through additional refinement cycles by repeating blocks 206-214, updating hyperparameters, retraining classifiers, or modifying hybridization logic to improve validation performance. Once process 200 achieves an acceptable classification accuracy based on validation data, it proceeds to subsequent deployment and fine-tuning steps.

At block 218, process 200 may optionally include a task-specific or environment-specific refinement phase. For example, upon conclusion of block 216, the resulting hybrid model may be somewhat generalized to a given task or may be amenable to refinement as further information regarding the ML task is available. Thus, after a hybrid model has been trained, it may be refined to account for the specific device or environment in which it will be deployed.

At block 218, process 200 may entail processing a deployment or runtime dataset using PCA according to the existing hyperparameters, providing the processed input to the hybrid model (trained DT and SVM modules and associated hybridization module) and evaluate results such as accuracy, confidence levels, etc. For example, if a model was trained to recognize alarm sounds (e.g., fire alarms, industrial klaxons, etc.), but then is deployed in a building that has specific alarm sounds of interest in addition to new sounds (e.g., elevator dings, mobile device notifications, etc.), the model may exhibit reduced real-world accuracy. Alternatively, if a model was trained to recognize electrical load behavior for a range of product types, but the model will only be deployed in association with specific product types, a model may be needlessly complex for the specific application in which it will be used.

Stated otherwise, additional refinement of a model may be desirable to tailor the model to a specific deployment setting. In such cases, an additional (optional) refinement phase may be used to account for variations in input data that may not have been fully captured in the original training dataset and better ensure that the model performs optimally within the unique conditions of its intended environment and task.

Therefore, at block, 220, process 200 may optionally determine whether adjustments to hyperparameters or model architecture are necessary based on deployment data. Adjustments may include refining PCA parameters, modifying weighting factors in the hybridization module, or re-training individual classifiers to account for real-world data distributions. In some embodiments, block 220 may entail determining an accuracy of the model on a validation set having similar data as the deployment data. In addition, or alternatively, if deployment data exhibits new variations or patterns in input signals, or class objects do not appear consistently in the data patterns, process 200 may adjust hyperparameters dynamically or prompt an operator to provide additional labeled data for fine-tuning. For example, in a machine monitoring application, process 200 may determine that the deployment environment includes specific types of motors that were underrepresented in the training set. To improve classification accuracy and/or computational requirements, process 200 may adjust the decision tree to prune branches corresponding to irrelevant machine types or re-optimize the SVM model with new hyperparameters that better reflect the actual operating conditions of the monitored equipment.

Evaluation methods may include real-time inference tests, performance monitoring over an extended period, or comparison against ground-truth data provided by system operators.

At block 222, if the hybrid model performs well enough on the deployment data or no variations in the data create cause to further refine, then process 200 deploy the model 228 for the specific task/device/environment. However, if refinement is desired, then process 200 may proceed to adjust parameters of the hybrid model at block 224. For example, if process 200 determines that classification accuracy has improved sufficiently based on deployment-specific refinements, it may proceed with model deployment. However, if further refinements are required, process 200 may continue iterative hyperparameter adjustments, incorporating additional deployment observations to further enhance classification robustness.

For example, at block 224, process 200 may adjust hyperparameters of the hybridization module to alter how classification outputs of the DT and SVM are used in creating a final output. For example, a device (such as a server or workstation) that is connected to control and/or supervise an IoT device may receive data from the IoT device regarding its deployment data and raw outputs of the DT and SVM models, together with the final classification outputs (e.g., from the evaluation performed at block 220). If deployment data reveals consistent inaccuracies, biases, or lost information due to how the hybridization module synthesizes classifier outputs, process 200 may adjust weighting factors for soft voting, modify decision thresholds for hard voting, or introduce additional validation steps to verify classification results. In some cases, deployment refinement may involve adjusting confidence thresholds for issuing an “unknown” classification. For example, in an industrial monitoring scenario, if the hybrid model frequently misclassifies newly observed signals, process 200 may determine that an “unknown” category should be used to flag ambiguous inputs for further review rather than assigning incorrect classifications.

In some embodiments, this step of adjusting the hybridization module hyperparameters may be done without necessarily retraining the DT and SVM models (or other models, if included). Validation may be performed on the hybrid model as a whole after modifying these hyperparameters, and if accuracy and outputs are satisfactory, then no modifications to the two (or more) models or the PCA (or other) data reduction module.

In some cases, however, hyperparameters or other structural aspects of the DT and SVM models may be adjusted to improve performance on the deployment data at block 226. This process of hyperparameter adjustment may follow a similar process as that of block 206-208. In some embodiments, as hyperparameter changes are selected, process 200 may involve re-training the hybrid model with deployment-specific data (whether provided by the device manufacturer, system integrator, or end-user, etc.) instead of or in addition to the original training data. For example, a manufacturer of a specialty device may provide an API or data library containing acoustic signatures of specific alarm signals for customers to use as they adjust parameters of a pre-trained model for their specific devices. Alternatively, a smart home security system may collect real-world sound samples of common, everyday office/warehouse/home sounds and, based on customer input, use some or all of this data to refine and improve the model's ability to continue to distinguish security-relevant sounds, such as breaking glass or forced entry, versus everyday noises, such as mobile device notifications or television audio. In further instances, the type of DT or SVM utilized may allow for DT and/or SVM modification without retraining, such as through grafting, branch pruning, or weight adjustments.

At block 228, process 200 deploys the refined hybrid classification model to an edge device or computing system, ensuring that it is optimized for real-time inference in its intended operational environment. Deployment may involve converting the trained model into a format suitable for the target hardware, such as quantizing parameters for execution on low-power microcontrollers or compiling the model for an embedded inference engine. In some implementations, deployment may include updating the model on existing devices via firmware or software updates, allowing periodic model refinement without requiring physical hardware modifications. Once deployed, the hybrid model operates autonomously, classifying new input data in real-time and adapting to environmental variations based on the refinements performed during this phase.

In other embodiments, deploying the model may include using the model as an input to a transistor layout program to design an ASIC that will perform the ML task subject to given power, chip size, and other constraints.

In some embodiments, process 200 may include mechanisms for continuous learning, wherein deployed models periodically transmit select inputs-such as highly confident classifications, ambiguous signals, or misclassified data-back to a central server for further refinement. The central server may aggregate deployment data across multiple devices, retrain the model with new data, and push optimized model updates back to the devices. This approach allows for ongoing improvement of classification accuracy while minimizing the computational burden on resource-constrained edge devices.

### Example Hybrid Machine Learning Runtime Process

FIG. 3 is a flow diagram illustrating an example runtime process 300 utilizing a hybrid machine learning model as described herein. As described below, a particular implementation can omit some or all illustrated features/steps, may be implemented in some embodiments in a different order, and may not require some illustrated features to implement all embodiments. In some examples, an apparatus (e.g., computing device 110, etc.) in connection with FIG. 1 can be used to perform all or part of example runtime process 300. And, the hybrid machine learning model may be developed according to some or all of the steps and approaches of the process 200 of FIG. 2. However, it should be appreciated that other suitable processing hardware for carrying out the operations or features described below may perform process 300.

At process block 302, sensor data is received, such as sensor data that may be detected locally by an edge or IoT device. In some examples, the sensor data may be received directly from a sensor such as an optical camera, high speed camera, depth camera, an x-ray detector, an infrared sensor, an ultrasound transducer, or the like. In other examples, the sensor data may be generated by a more integrated sensor component, such as an accelerometer, gyroscope, IMU, pressure sensor, temperature sensor, acoustic sensor/microphone, motion sensor, electrical sensor, or the like. In further embodiments, the sensor data may be received from a remote resource such as a remotely located sensor, another IoT device, a library or database containing sensor data (such as a patient medical record), or another source. For example, the sensor data may correspond to medical data such as data contained in the heart disease dataset 102 or the breast cancer dataset 104, as described above with respect to FIG. 1.

At process block 304, process 300 may access a trained hybrid data analysis model that has been configured to process data of the type received at block 302. In some examples, the trained hybrid analysis model may correspond to a model developed as described in process 200, of FIG. 2. The trained hybrid data analysis model may integrate one or more existing or new classifier models, such as logistic regression, decision tree, Very Fast Decision Tree (or Hoeffding Tree), random forest, gradient-boosted decision trees, oblique decision trees, support vector machines (linear or kernel), twin bounded SVMs (e.g., for imbalanced data and anomaly detection), least squares SVM, online/incremental SVM, embedded SVM, naïve Bayes probabilistic classifiers, k-nearest neighbors, or the like. In certain examples more than two models may be utilized, such as an odd number of models, or models with varying hyperparameter settings, or multiple types of models of different design.

At process block 306, the sensor data is processed using a data reduction or feature extraction step, such as via a principal component analysis (PCA) module according to a plurality of PCA hyperparameters. In some examples, the PCA module may process the sensor data by decreasing the dimensionality, while preserving original information regarding variance. For example, informative features or principal components may be extracted from the sensor data. In some embodiments, a training data set or deployment data set was used to refine the PCA hyperparameters to emphasize or isolate the components or features of the data that exhibit the highest variance and discriminatory power as to the specific classification task and output labels of the given ML task.

At process block 308, the PCA-processed sensor data is provided in parallel to a trained support vector machine (SVM) model and a trained decision tree (DT) model, or a grouping of multiple DT models, combinations of SVM and DT models and/or other models that lack the resource demands of neural network classifiers. In some examples, the SVM model may be configured to process nonlinear data to predict classifications with high accuracy. For example, the SVM module may identify binary or multiclass classifications, as well as regressions with continuous predictions. Moreover, in some examples, the DT module may be configured to generate interpretable productions regarding underlying data structures. For example, the DT module may create classifications or regressions for categorical target variables, such as those representatives of discrete values from one or more individual sensors.

At process block 310, a first output is obtained from the SVM model. The first output is determined by the hyperparameters used in creating the SVM model, but may also be determined at least in part by hyperparameters of the hybridization module. As described above with respect to FIG. 2, the plurality of SVM hyperparameters may be determined using a grid search (or other approach) on PCA-processed training data. For example, the SVM hyperparameters may be configured to take into account one or more feature vectors extracted from the sensor data, and thus may be “learned” or tuned based on training data or specific deployment-type data for an IoT device running process 300.

At process block 312, a second output is obtained from the DT model. The second output is determined by the hyperparameters used in creating the DT model. As described above with respect to FIG. 2, the plurality of DT hyperparameters may also be determined using a grid search (or other approach) on PCA-processed training data. For example, the DT hyperparameters may identify suitable combinations and capture information regarding underlying patterns in the sensors data and/or features extracted from the sensor data. Thus, the DT (per its refined hyperparameters) is “learned” or tuned to the type of data that will be sensed by a device running process 300.

At process block 314, the first output and the second output are provided to a trained hybridization module and processed at block 316. In some examples, the trained hybridization module may perform a data integration or synthesis algorithm, such as a voting process or similar algorithm, according to a set of learned hyperparameters. For example, the voting process may compare a predicted accuracy of the output of each classification model, and may select the one with highest overall confidence score, highest aggregate score, majority/consensus vote, etc.

At process block 318, process 300 may output a final classification or prediction based on the decisions and processing embedded in the hybridization module. As described above with respect to FIG. 1, the output may be utilized by the IoT device to adjust a local setting or take an action (e.g., storing an image, turning on a light, initiating a command to a device, generating a notification, etc.), or may be sent via communications system 118 and communication network 130 to another device (such as another IoT device, a hub, a server, etc.), etc. For example, the output may include a report with a prediction or classification, as well as a corresponding accuracy or confidence level. Moreover, in some examples, the classification or predication may be saved in the memory 114 and used to retrain or update the hybrid data analysis model.

Alternatively, or in addition to block 318, process 300 may also log relevant deployment data (such as environment specific data) for future refinement of the hybrid model. For example, process 300 may generate a classification with a given confidence level based on a given runtime-detected sensor reading (e.g., an image or a window of an electrical signal, etc.). Subsequently, another sensor, environmental characteristic, another IoT device, or other occurrence may confirm (or prove incorrect) the classification, thereby giving the IoT device a confirmed ground truth label. For example, where a device reads an electrical load to determine force being applied by a motor as an indicator that an industrial valve was opened for an emergency venting or cooling process, a subsequent airflow, pressure, or temperature reading by another IoT device may confirm that the valve was in fact opened. Thus, the IoT device may log the electrical sensor data corresponding to the change in electrical load along with its classification output as a verified ground truth. The data and label may be stored with other, similar examples and used to later refine hyperparameters of the IoT device's classification module or future classification modules that may be used in the same specific environmental/task deployment.

### Example Optimization Process for Neural Network Model

The proposed hybrid Machine Learning (ML) model aims to design resource-efficient inference models for IoT edge applications. These models can be deployed efficiently using microcontrollers or used to design custom hardware inference models. By integrating contemporary ML techniques to create optimized inference models that improve resource utilization and by leveraging synergies between ML algorithms, the hybrid model enhances processing capabilities while optimizing resource usage for IoT edge devices.

The model combines a dimensionality reduction technique with classification ML algorithms to form a hybrid framework. PCA, DT, and SVM are incorporated to address scenarios where large datasets may cause DT or SVM to struggle due to the curse of dimensionality. PCA reduces the dataset's dimensionality, improving classifier performance while decreasing the computational resources required for training and deploying models on resource-constrained IoT edge devices.

PCA is an unsupervised ML technique used to reduce the dimensionality of datasets. Its primary objective is to transform a high-dimensional dataset into a lower-dimensional representation while preserving as much of the original information as possible. This is achieved by identifying principal components, which are orthogonal vectors capturing the directions of maximum variance in the data. These components form a new coordinate system, and the data is projected onto this reduced-dimensional space. The first principal component corresponds to the direction with the highest variance, and subsequent components follow in decreasing order of variance. By selecting a subset of the principal components that capture most of the variance, PCA enables efficient storage, visualization, and analysis of high-dimensional data. PCA also finds applications in noise filtering, data compression, and feature extraction. It operates under the assumption that high-dimensional data often contains redundancy, and a lower-dimensional subspace can explain a large portion of the variation. By projecting the data onto this reduced-dimensional space, PCA provides insights into the underlying structure and relationships within the dataset. In some examples, PCA can be sensitive to the scale of the features, and data normalization is typically performed before applying PCA to ensure accurate results.

DTs are ML techniques used for classification and regression problems. They represent decision-making processes through a hierarchical structure of nodes and branches. At each node, the optimal split is determined using metrics such as Gini impurity or entropy, which help create distinct branches. Pruning techniques can be applied to address overfitting and simplify the tree's structure. DTs handles both categorical and numerical data, making them versatile for various applications. Ensemble methods, such as random forest and gradient boosting, can enhance decision tree performance by combining multiple trees. While decision trees offer interpretability, they can be sensitive to data fluctuations. Extensions and modifications to decision trees, such as decision stumps (shallow trees) and advanced algorithms like XG-Boost, further extend their capabilities.

SVMs are supervised ML techniques used for classification and regression tasks. The principle behind SVMs is to determine an optimal line or hyperplane that separates different classes of data points while maximizing the margin between them. The goal is to achieve a maximum margin, which is the distance between the hyperplane and the nearest data points in each class, known as support vectors. These support vectors are crucial in defining the hyperplane and computing the margin. By focusing on support vectors, SVMs provide a computationally efficient approach to classification. To handle complex data patterns, SVMs use the kernel method, which includes linear, polynomial, Gaussian Radial Basis Function (RBF), and sigmoid kernels. This method enables SVMs to map data into a higher-dimensional space where the data may become more separable, without explicitly computing the coordinates in that space. By identifying which side of the hyperplane a data point falls on, SVMs can classify new data into the corresponding classes. SVMs are known for their ability to handle high-dimensional data, process complex datasets efficiently, and resist overfitting. However, fine-tuning hyperparameters is required to optimize performance.

First, PCA is used to reduce the number of features by extracting the most informative components, alleviating computational complexity and memory demands. Second, DT and SVM are fine-tuned using the output of PCA to form the hybrid model. The predictions from these models are combined using a voting mechanism and averaging, resulting in an efficient and effective inference model. This implementation ensures feasibility for deployment on IoT edge devices, enabling real-time classification tasks in a low-power, energy-efficient manner.

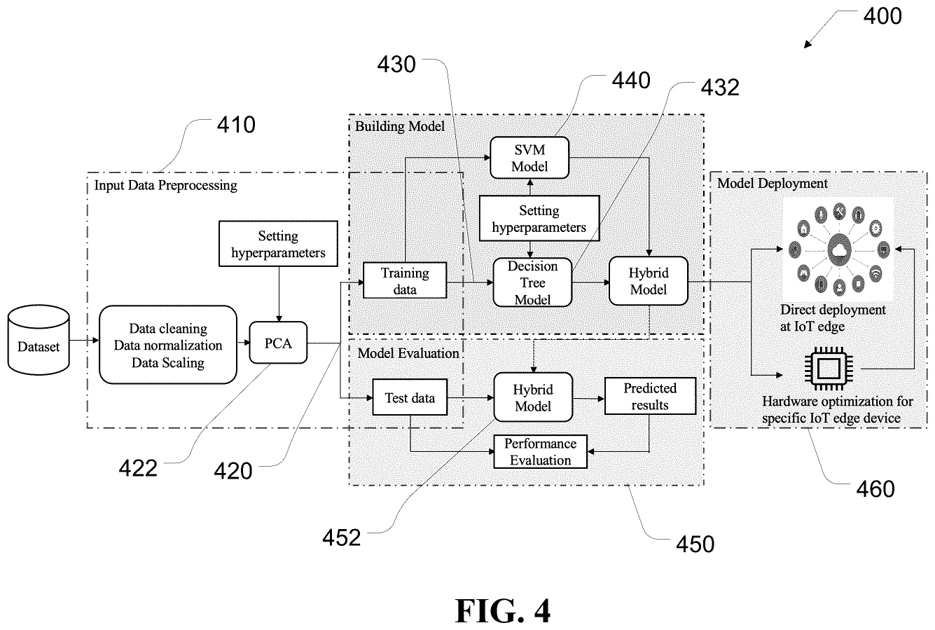

FIG. 4 shows a conceptual illustration of a hybrid model architecture and development framework 300, incorporating PCA, DT, and SVM for dimensionality reduction and classification for a resource-efficient inference model (whether as a hardware implementation or lightweight application for IoT edge devices).

Upon acquiring the data at step 410, an input dataset preprocessing involves necessary cleaning, normalization, and scaling of the data. These preprocessing techniques are applied to ensure the data is accurate and consistent, which in turn helps improve the overall performance of the model.

At step 420, optimizing the hyperparameters of PCA 422 begins by splitting the preprocessed data into training and validation sets. A grid search is then employed to explore various combinations of PCA hyperparameters, with the goal of determining the optimal values, such as the number of principal components. Once the ideal hyperparameters are identified, PCA 422 is applied to the training set using the selected values. The trained PCA model is then used to transform both the training and validation sets, ensuring that they are properly adjusted according to the chosen parameters.

At step 430, hyperparameter tuning and training of the decision tree 432 classifier starts with the transformed training and validation sets from the step 420. A grid search is performed to explore different hyperparameter combinations for the decision tree model, with the aim of finding the optimal set. The decision tree classifier is trained on the training set, and its performance is evaluated on the validation set. If the performance does not meet expectations, the grid search is repeated with different hyperparameter values to fine-tune the model and achieve optimal results.

At step 440, hyperparameter tuning and training of the SVM classifier follows a similar process to step 430, using the transformed data from PCA. A grid search is used to explore various hyperparameter combinations to identify the optimal values that enhance the SVM classifier's performance. The SVM model is trained using the training set, and performance is assessed on the validation set. If the performance is unsatisfactory, the grid search process is iteratively repeated to refine the model and maximize its classification accuracy.

At step 450, evaluation of hybrid model 452 involves combining the optimized decision tree classifier and SVM classifier into a unified framework. The predictions from both models are combined using a voting mechanism to make the final prediction. A comparative analysis is conducted to evaluate the accuracy of the hybrid model against the individual classifiers. If the performance of the hybrid model does not meet the desired criteria, the hyperparameter tuning process for PCA, decision tree, and SVM classifiers is revisited and iteratively refined until satisfactory results are achieved.

At step 460, a hybrid model deployment takes place once the hybrid model has demonstrated satisfactory performance. The model can be deployed directly on IoT edge devices using microcontrollers for real-time classification tasks. Further optimization techniques, such as quantization, can be applied to customize the model for specific IoT edge applications, ensuring efficient performance in resource-constrained environments.

### Experimental Results

This section outlines the experimental design and results of the proposed method. To evaluate the efficacy of the proposed methodology, a comprehensive assessment is carried out using five well-established classification datasets: Heart Disease, Breast Cancer Wisconsin (Diagnostic), Lung Cancer, Fetal Health, and Pima Indian Diabetes. The Heart Disease dataset contains 1,025 instances and 10 input features. The Breast Cancer Wisconsin (Diagnostic) dataset consists of 30 input features and 569 instances. The Lung Cancer dataset includes 309 instances and 15 input features. The Fetal Health dataset comprises 21 input features and 2,126 instances, and the Pima Indian Diabetes dataset has 11 input features and 767 instances. The experimental process involves training the classification datasets using the proposed hybrid workflow. The training and testing data are randomly partitioned in an 80:20 ratio to generate the hybrid model. The performance of the hybrid model is subsequently evaluated based on accuracy.

In the experimental design, the first step involves implementing input data preprocessing procedures. These procedures consist of data cleaning, normalization, and scaling, aimed at improving the accuracy and consistency of the input data. After preprocessing the input dataset, a grid search technique is used to optimize the hyperparameters of a hybrid model comprising PCA, DT, and SVM. The goal is to find the best combination of hyperparameters that delivers the best performance for each algorithm. Specifically, for PCA, the focus is on selecting the optimal number of orthogonal components that effectively capture the significant variance in the input features. This reduces the dimensionality of the input features by condensing the most relevant information into a smaller subset of transformed features, which are then used as input for the DT and SVM models. This dimensionality reduction also results in more efficient memory utilization and computational resource usage, making it suitable for resource-constrained IoT edge devices with limited processing power and storage capacity. Furthermore, it reduces energy consumption when implementing the hybrid inference model on IoT edge devices, minimizing the computational workload and data movement, which enables real-time, low-latency predictions that are critical for time-sensitive IoT applications.

TABLE 1
Optimized hybrid model input configurations

| | Original | Number of | Features |
|---|---|---|---|
| | number of | features in | reduced |
| Dataset | input features | hybrid model | (%) |
| Heart Disease | 10 | 3 | 70 |
| Breast Cancer | 30 | 12 | 60 |
| Lung Cancer | 15 | 7 | 53 |
| Fetal Health | 21 | 10 | 52 |
| Pima Indian Diabetes | 11 | 5 | 55 |

Table 1 above shows the optimized hybrid model input configurations after applying PCA. For the Heart Disease dataset, there is a reduction from 10 features to 3 transformed features, leading to a 70% decrease in dimensionality. The Breast Cancer dataset shows a 60% reduction in dimensionality, with the number of features decreasing from 30 to 12. The Lung Cancer, Fetal Health, and Pima Indian Diabetes datasets exhibit reductions in dimensionality of 53%, 52%, and 55%, respectively.

Subsequently, the hyperparameters of DT and SVM in the hybrid model are fine-tuned. To develop a robust hybrid model specifically designed for IoT applications, we carefully select the hyperparameters for DT and SVM. For DT, we pre-prune the tree before training, selecting the following optimal hyperparameters: the criterion for DT is set to Gini impurity due to its computational efficiency compared to entropy and its tendency to produce shorter, more cohesive branches. The maximum depth of the decision tree is set to 10 to control overfitting and model complexity. The minimum sample split is set to 2, ensuring that each node split requires at least 2 samples. The splitter strategy is set to “best,” selecting the best split strategy at each node during tree construction. Other hyperparameters are left at their default values. Similarly, for SVM, we select the sigmoid kernel to optimize hardware implementation and efficiency, as it involves simpler mathematical operations compared to more complex kernels like Gaussian (RBF). This choice reduces computational complexity and memory requirements, making it more suitable for hardware optimization. The regularization parameter (C) is set to 100 and the kernel coefficient (Gamma) to 10 based on experimentation. The remaining hyperparameters are maintained at their default values. Fine-tuning these hyperparameters aims to optimize the performance and effectiveness of the hybrid model.

After determining the optimal hyperparameters for the hybrid model, comprehensive training and testing are performed on the transformed datasets obtained through PCA, using both DT and SVM. This allows the generation of an optimized hybrid inference model specifically designed for resource-constrained IoT edge devices. The performance of the hybrid model, as shown in Tables 2 and 3 below, is evaluated using two output prediction techniques: hard voting and soft voting.

TABLE 2
Evaluation of hybrid model training performance

| | Accuracy Hard | Accuracy Soft |
|---|---|---|
| Dataset | Voting (%) | Voting (%) |
| Heart Disease | 96.24 | 97.5 |
| Breast Cancer | 97.52 | 99.26 |
| Lung Cancer | 97.77 | 98.51 |
| Fetal Health | 99.26 | 99.65 |
| Pima Indian Diabetes | 99.75 | 99.87 |

TABLE 3
Evaluation of hybrid model testing performance

| | Accuracy Hard | Accuracy Soft |
|---|---|---|
| Dataset | Voting (%) | Voting (%) |
| Heart Disease | 95.12 | 96.67 |
| Breast Cancer | 95.39 | 98.04 |
| Lung Cancer | 93.54 | 95.23 |
| Fetal Health | 96.58 | 98.53 |
| Pima Indian Diabetes | 96.09 | 99.02 |

Upon analyzing the results in Tables 2 and 3, it is observed that the soft voting technique consistently provides better output predictions for both the training and testing phases of the hybrid model. Additionally, the performance of the hybrid model is compared to that of individual DT and SVM models for both training and testing, as presented in Table 4 below. The hybrid model's predictions are comparable to those of the individual models, even though the latter are not optimized and have higher computational complexity, memory demands, power consumption, and latency. The evaluation further indicates that the average accuracy loss of the hybrid inference model remains under 4%, demonstrating its robustness and effectiveness.

TABLE 4
Performance evaluation of DT and SVM for training and testing

| | DT | | SVM | |
|---|---|---|---|---|
| | Training | Testing | Training | Testing |
| | Accuracy | Accuracy | Accuracy | Accuracy |
| Dataset | (%) | (%) | (%) | (%) |
| Heart Disease | 99.14 | 98.50 | 98.00 | 96.08 |
| Breast Cancer | 99.99 | 98.79 | 99.58 | 94.26 |
| Lung Cancer | 99.71 | 97.74 | 98.00 | 96.45 |
| Fetal Health | 99.99 | 97.00 | 99.99 | 97.00 |
| Pima Indian Diabetes | 99.95 | 99.00 | 96.00 | 93.53 |

The improvement is achieved while using simpler mathematical operations, highlighting the effectiveness of the proposed method. Moreover, this hybrid model is suitable for deployment on IoT edge devices and can be further optimized using hardware techniques. By leveraging ASICs, more efficient implementations can be achieved, improving the model's overall performance on IoT edge devices. The research findings demonstrate the promising capabilities of the optimized hybrid model in delivering accurate predictions while addressing the computational and resource constraints typically encountered in IoT edge devices. The hybrid model shows enhanced accuracy and reliable performance across multiple datasets, emphasizing the effectiveness of the proposed method and its potential to improve classification tasks in diverse domains.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for generating a task-specific and environment-specific hybrid machine learning (ML) model for an Internet of Things device (IoT), the method comprising:
i. receiving information defining a classification task to be performed by the IoT device based on data sensed from an environment in which the IoT device will be deployed;
ii. determining a training data set corresponding to the classification task and environment;
iii. obtaining a hybrid ML model comprising a data reduction module, at least one decision tree (DT) model, at least one support vector machine (SVM) model, and a hybridization module;
iv. determining an initial plurality of hyperparameters of the data reduction module, wherein at least one of the hyperparameters is limited in adjustability by a maximum or minimum value, according to a task-specific attribute, and processing the training data set using the data reduction model according to its hyperparameters to create a reduced training data set;
v. determining an initial plurality of hyperparameters for the DT model and an initial plurality of hyperparameters for the SVM model, based at least in part on: the plurality of hyperparameters of the data reduction module, a resource constraint of the IoT device, and the information defining the classification task to be performed by the IoT device;
vi. training the DT model and SVM model using the reduced training data set, according to the plurality of hyperparameters for the DT model and plurality of hyperparameters for the SVM model;
vii. determining an initial plurality of hyperparameters of the hybridization module, the hyperparameters configured to cause the hybridization module to integrate outputs of the DT model and SVM model according to the information defining the classification task to be performed;
viii. adjusting an output format of the DT model and SVM model to conform to the hyperparameters of the hybridization module;
ix. evaluating performance of the hybrid ML model, and if performance does not meet a criteria of the information defining the classification task, iteratively adjusting at least one of the plurality of hyperparameters of the data reduction module, the DT model, and the SVM model, re-training the DT model and SVM model, and re-evaluating performance of the hybrid ML model; and
x. after performance of the hybrid ML model meets the criteria of the information defining the classification task, deploying the hybrid ML model for use in the IoT device.
